(19) United States
(12) Patent Application Publication
(10) Pub. No.: US 2006/0102683 A1
(43) Pub. Date: May 18, 2006

(54) Adjustable angle magazine with pick-off pivot assembly

(76) Inventors: John W. Schnell, Jackson, TN (US); Alan Phillips, Jackson, TN (US)

Correspondence Address: THE BLACK & DECKER CORPORATION, 701 EAST JOPPA ROAD, TW199, TOWSON, MD, 21286, US

(21) Appl. No.: 10/664,465

(22) Filed: Sep. 17, 2003

Related U.S. Application Data
(60) Provisional application No. 60/411,563, filed on Sep. 18, 2002.
(60) Provisional application No. 60/471,641, filed on May 19, 2003.

(51) Int. Cl. B25C 5/06

(52) U.S. Cl. 227/119; 227/120; 227/136

(57) ABSTRACT

An adjustable angle magazine for a nail gun includes a pick-off pivot assembly. The pick-off pivot assembly pivotally couples the adjustable angle magazine to an adjustable angle nose casting assembly of the nail gun. Further, the pick-off pivot assembly increases the instances that a nail loaded into to the adjustable angle magazine is presented under a driver blade of the nail gun in a correct position.

### CROSS REFERENCE TO RELATED APPLICATION

The present application claims priority under 35 U.S.C. §119(e) to the U.S. Provisional Application Ser. No. 60/411,563, filed on Sep. 18, 2002, and the U.S. Provisional Application Ser. No. 60/471,641, filed on May 19, 2003. The U.S. Provisional Applications 60/411,563 and 60/471,641 are herein incorporated by reference in their entireties.

### FIELD OF THE INVENTION

The present invention generally relates to the field of power tools, and particularly to an adjustable angle magazine including a pick-off pivot assembly for use with a nail gun, such as a pneumatic nail gun.

### BACKGROUND OF THE INVENTION

The use of power tools, such as nail guns is commonplace in the construction industry. Devices, such as the nails employed with nail guns are often provided in collated strips. These collated nail strips set each nail at a specific angle relative to each other. The particular angle of collation enables functionality with the pneumatic nail gun within which the nails are used. Thus, it is often the case that particular packets of collated nail strips, collated at particular angles, are limited in their application to particular nail guns.

The collated nail strips are loaded into the nail gun through a nail loading assembly, often identified as the nail gun magazine. The nail gun magazine provides storage capabilities for the nails as well as the ability to present the nails to a nail driving assembly. Typically, the nail driving assembly uses various systems, such as pneumatic systems, to drive a driver blade through a nose casting. The nose casting is coupled with the nail gun magazine and is where an individual nail is presented for the driver blade to strike.

With typical nail guns, it may be the case that an operator, wishing to employ a variety of nail types or nails collated at various angles on a particular job, is required to use multiple nail guns. This may increase production costs and decrease productivity in the work place. Further, it may often be the case that the collated nail strips loaded into the nail gun may include the wrong type of nail or have the wrong collation angle. As a result, the nails presented within the nose casting are in an incorrect position and thus, as the driver blade strikes the incorrectly positioned nail it may damage the nail gun or the operator.

Therefore, it would be desirable to provide the ability to use a variety of nail types and nail strip collation angles within a nail gun where the nail is presented correctly within the nose casting for striking by the driver blade.

### SUMMARY OF THE INVENTION

Accordingly, the present invention is directed to a pick-off pivot assembly disposed within a nail loading assembly, such as an adjustable angle magazine. By using a pick-off pivot assembly a nail gun employing a cylindrical driver blade may be used to drive both round-head and clipped-head nails. This is advantageous because of the increased robustness of a cylindrical driver blade versus a crescent shaped driver blade and that a cylindrical driver blade is cheaper. In a first aspect of the present invention, a nail loading assembly comprising a housing coupled with a pick-off pivot assembly is provided. The pick-off pivot assembly pivotally couples the housing to a nail driving assembly and provides a nail, stored in the housing, to the nail driving assembly. The pick-off pivot assembly presents the nail to the nail driving assembly in the correct position.

In a second aspect of the present invention, an adjustable angle magazine for use with a nail gun is provided. The adjustable angle magazine comprises a housing coupled with a pick-off pivot assembly, on a first end, which enables the rotation of the adjustable angle magazine relative to a nail driving assembly to which the pick-off pivot assembly couples. The pick-off pivot assembly further provides a nail, stored in the housing, to the nail driving assembly and ensures that the nail is presented in the correct position to be driven. An adjustment assembly is disposed proximal to a second end of the housing and affixes the position of the housing relative to the nail gun.

In a third aspect of the present invention, an adjustable angle nail gun is provided. The adjustable angle nail gun comprises a handle with a first end and a second end coupled with a fastening assembly. A nail driving assembly including a driver blade is coupled with the first end of the handle and is for driving a nail. An adjustable angle nose casting assembly including is coupled with the nail driving assembly. The adjustable angle nose casting assembly receives the nail and enables the operational engagement of the driver blade with the nail. An adjustable angle magazine is pivotally coupled with the adjustable angle nose casting assembly. A pick-off pivot assembly is coupled with a first end of the adjustable angle magazine and enables the pivotal coupling of the adjustable angle magazine with the adjustable angle nose casting assembly. An adjustment assembly disposed proximal to the second end of the adjustable angle magazine couples with the fastening assembly. The pick-off pivot assembly enables the adjustable angle magazine to be positioned at various angles relative to the adjustable angle nose casting assembly and present the nail to the nail driving assembly in the correct position.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an adjustable angle magazine including a pick-off pivot assembly in accordance with an exemplary embodiment of the present invention;

FIG. 2A is an illustration of an adjustable angle nail gun including the adjustable angle magazine with the pick-off pivot assembly engaging with an adjustable angle nose casting assembly and a first fastening assembly;

FIG. 2B is an exploded view illustration of the adjustable angle nail gun including the pick-off pivot assembly, the adjustable angle magazine, the adjustable angle nose casting assembly, and the first fastening assembly;

FIG. 3 is an illustration of a second exemplary embodiment of an adjustable angle nail gun including a second fastening assembly coupling with an adjustable angle magazine coupled with an adjustable angle nose casting assembly via a pick-off pivot assembly;

FIG. 4A and 4B are isometric views of the pick-off pivot assembly engaging a collated strip of clipped-head nails;

FIG. 5 is an expanded view illustrating the pick-off pivot assembly engaged with a collated nail strip of clipped-head nails, presenting the clipped-head nails to the adjustable angle nose casting assembly;

FIG. 6 is a side view illustration of the pick-off pivot assembly disposed in the adjustable angle magazine and coupled with the adjustable angle nose casting assembly, wherein the pick-off pivot assembly is presenting the round-head nails to the adjustable angle nose casting assembly; and

FIG. 7 is a side view illustration of the pick-off pivot assembly disposed in the nail loading assembly coupled with the adjustable angle nose casting assembly, wherein the pick-off pivot assembly is engaged with a collated nail strip of clipped-head nails and is presenting the clipped-head nails to the adjustable angle nose casting assembly.

### DETAILED DESCRIPTION OF THE INVENTION

Reference may now be made in detail to the presently preferred embodiments of the invention, examples of which are illustrated in the accompanying drawings.

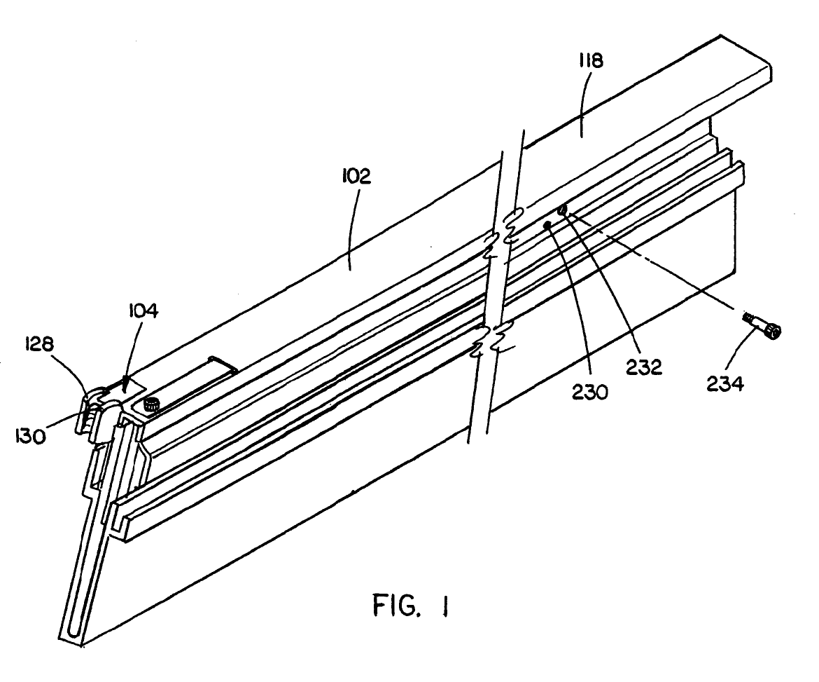

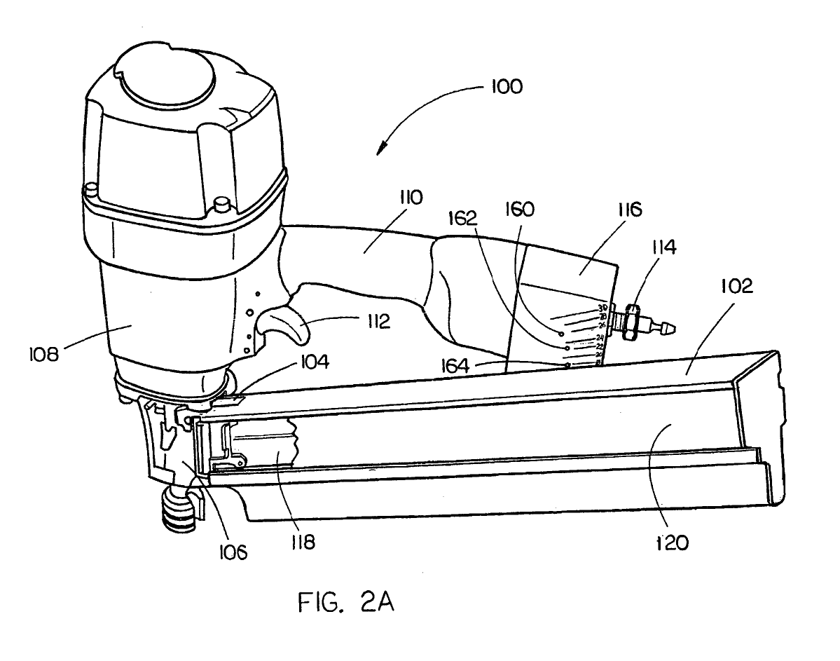

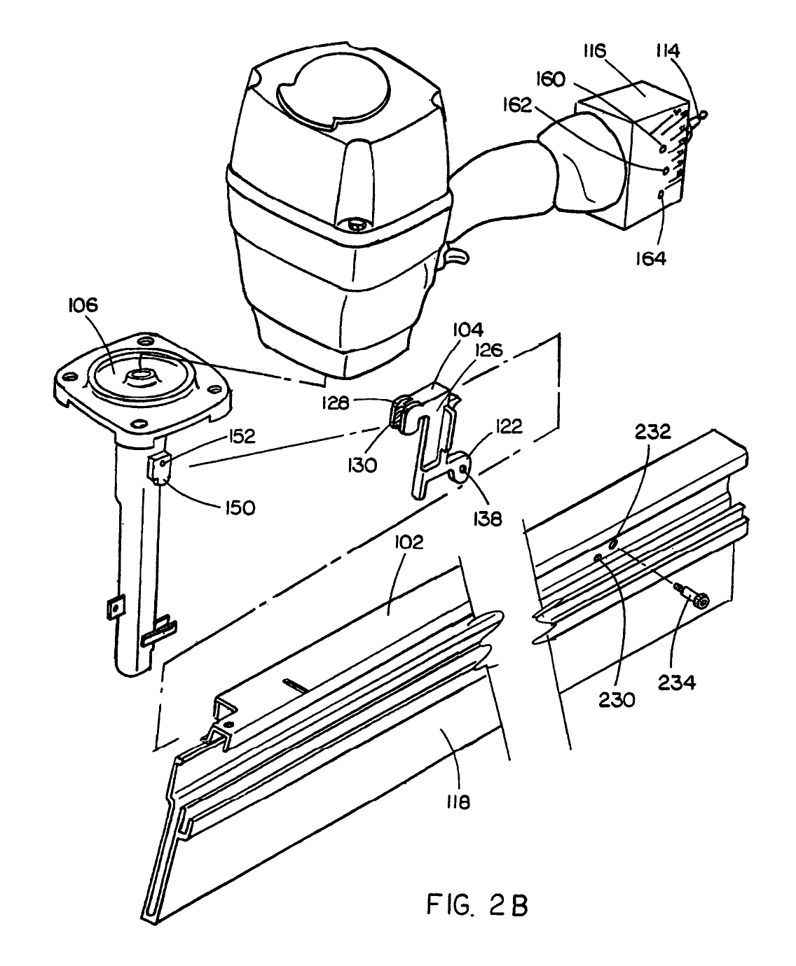

Referring generally now to FIGS. 1 through 2B, an adjustable angle nail gun 100 is shown. The adjustable angle nail gun 100 comprises an adjustable angle magazine 102 including a pick-off pivot assembly 104. The adjustable angle magazine 102 preferably comprises a housing 118 and a cover 120 capable of being removed from the housing 118. For example, the cover 120 may slide on and off the housing 118 or may utilize a compression lock system to couple with the housing 118. The cover 120 may comprise a single section or may comprise a plurality of sections each independently engaged with the housing 118.

The adjustable angle magazine 102 provides the operator of a nail gun the ability to use a variety of nail types collated at a variety of angles within the same nail gun. The housing 118 is configured generally to appear as a standard nail gun magazine with the cover 120 slidably coupled with it. The housing 118 may be configured for operation without the cover 120. In alternative embodiments, the housing 118 may be coil-type casing where the connected nails are arranged in a long belt, which winds around a spool. The coil-type casing may be configured in a variety of ways, such as a horizontal coil-type casing or a vertical coil-type casing. The cover 120 may be configured to operate with alternative embodiments, such as the coil-type casing, or may not be included. It is understood that alternative design embodiments of the housing 118 and cover 120 may be employed and do not depart from the scope and spirit of the present invention.

Preferably, the pick-off pivot assembly 104 pivotally couples the adjustable angle magazine 102 with an adjustable angle nose casting assembly 106. The adjustable angle nose casting assembly 106 is coupled with a casing 108. The casing 108 is internally disposed with a nail driving assembly comprising, in part, a driver blade which operably engages with the adjustable angle nose casting assembly 106. The casing 108 is further coupled with a handle 110 including a trigger assembly 112 which actuates the nail driving assembly. The handle 110 is disposed with a compressor connector 114 and the handle 110 is coupled with a first fastening assembly 116. The first fastening assembly 116 adjustably couples with the adjustable angle magazine 102.

The housing 118 is disposed with an adjustment assembly comprising a first angular connection site 130 and a second angular connection site 132. These angular connection sites may be engaged by a first bolt 134 which couples to a first fastening assembly 116 coupled with the handle 110 of the adjustable angle nail gun. The position of the first and second angular connection sites 130 and 132 enables the first or second angular connection site 130 and 132 to engage with a plurality of angular adjustment sites disposed on the first fastening assembly 116 and provide a specific angle of presentation of the adjustable angle magazine 102 relative to the adjustable angle nose casting assembly 106. The angular connection sites may be engaged by a variety of fasteners, such as screws, pins, and the like. The fasteners are extended through the first or second angular connection site 130 or 132 to engage with the nail gun fastening assembly. Upon engagement the fasteners secure the position of the adjustable angle magazine 102 relative to the adjustable angle nail gun 100. The fasteners may be removed from the nail gun fastening assembly, allow for the re-adjustment of the adjustable angle magazine 102, and then re-engage the nail gun fastening assembly.

The first fastening assembly 116 includes the plurality of angular adjustment sites, exemplified by a first angular adjustment site 160, a second angular adjustment site 162, and a third angular adjustment site 164. In operation the bolt 134 operably engages through either the first or second angular connection site 130 or 132, of the adjustable angle magazine 102, and couples with any one of the plurality of angular adjustment sites. The first fastening assembly 116 is further disposed with a plurality of angle identifiers. The angle identifiers are a series of indicators associated with a printed number (i.e., 30, 29, 28, 27 . . . ) which corresponds to the angle of presentation of the adjustable angle magazine 102 to an adjustable angle nose casting assembly 106. It is contemplated that the angle identifiers may be a label with the numbers printed upon them which may be adhered to the first fastening assembly 116. Alternatively, the numbers may be engraved or painted upon the first fastening assembly 116.

In the preferred embodiments, shown in FIGS. 1 through 7 the pick-off pivot assembly 104 comprises a first mounting member 122 and a second mounting member 124 coupled with a seating member 126. The seating member 126 further comprises a first pivot-head 128 and a second pivot-head 130. The first pivot-head 128 includes a first pick-off rib 132 and the second pivot-head 130 includes a second pick-off rib 134. The first and second pick-off rib 132 and 134 are internally disposed on the first and second pivot-head 128 and 130 for engagement with a nail as the nail is loaded into the pick-off pivot assembly. The first and second pick-off ribs 128 and 130 partially encompass a driver blade bore 136 which is also partially disposed on the seating member 126.

A first fastening point 138 is disposed on the first mounting member 122. The first fastening point 138 enables engagement by a fastener, such as a pin, clip, bolt, screw, and the like, with the first mounting member 122 and the adjustable angle magazine 102. A second fastening point 140 is disposed on the second mounting member 124 enabling similar functionality as the first fastening point 138. The configuration of the first and second mounting member 122 and 124 may vary as well as the location of the first and second fastening point 138 and 140.

FIG. 2B shows that the adjustable angle nose casting assembly 106, which engages with the pick-off pivot assembly 104, comprises a cradle 150 and a cradle fastening assembly 152. The cradle 150 is configured to receive the first and second pivot-head 128 and 130. Once located within the cradle 150 the first and second pivot-head 128 and 130 may pivot accordingly to accommodate a change in the angle of presentation of the adjustable angle magazine 102 relative to the adjustable angle nose casting assembly 106. A cradle fastening assembly 152, preferably comprises a fastener which engages with a first and second pin receiver located on opposite sides of the cradle 150 which allows the fastener, such as a pin, clip, bolt, post, and the like, to be inserted through. The fastener provides a stop against the first and second pivot-head 128 and 130 hinders their removal from the cradle 150. The ability of the first and second pivot-head 128 and 130 to pivot while in operational engagement with the cradle 150 is not hindered by the fastener.

Further, the adjustable angle magazine 102 including the pick-off pivot assembly 104, may be disposed with various other devices and mechanisms. These may include an articulating pusher assembly, a nail checker assembly, a nail lockout assembly, a nail spacing verifier assembly, a nail shank pawl assembly, and a pinion nail verifier assembly. Additionally, the adjustable angle magazine may be enabled as a top-loading mechanism, a side-loading mechanism, and the like as may be contemplated by one of ordinary skill in the art.

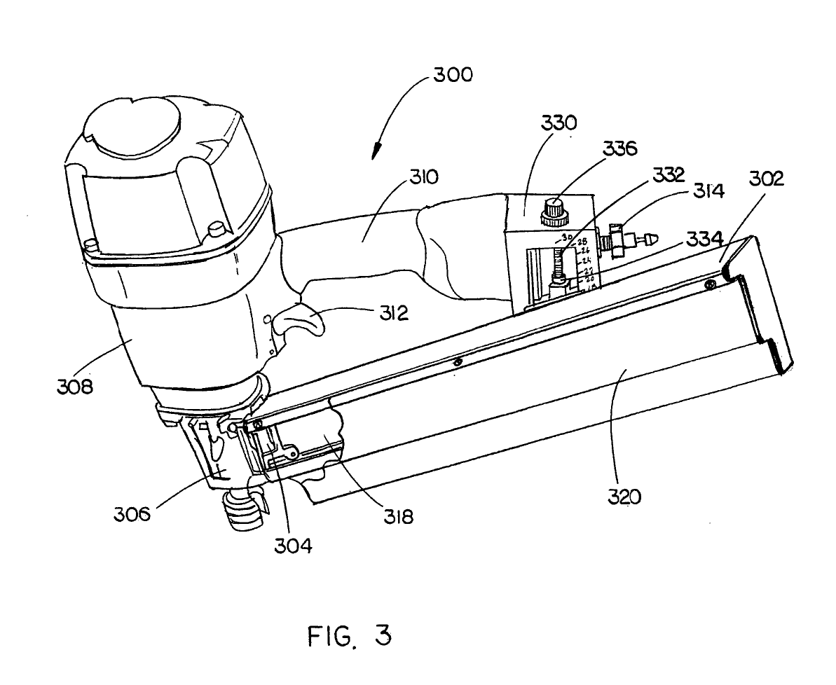

In FIG. 3, an adjustable angle nail gun 300 is shown, including a second fastening assembly 330. The second fastening assembly 330 is coupled with a handle 310 coupled with a compressor connection assembly 314. Preferably, the second fastening assembly 330 is a worm drive assembly including a spirally threaded shaft 332 operably engaging with a spirally threaded sleeve 334. The sleeve 334 at least partially encompassing the threaded shaft 332 and being spirally threaded on an internal surface. The threaded shaft 332 being coupled with a mechanical rotation assembly 336. The mechanical rotation assembly 336 may be operably engaged by the operator of the adjustable angle nail gun 300. An operator may provide rotation to the mechanical rotation assembly 336 which in turn moves the sleeve 334 up or down the threaded shaft 332 depending on the direction of the rotation imparted. Similar to the first fastening assembly 116, the second fastening assembly 330 includes angle identifiers.

The sleeve 334 is coupled with an adjustable angle magazine 302 including a pick-off pivot assembly 304. The adjustable angle magazine 302 is coupled with an adjustable angle nose casting assembly 306 which is coupled with a casing 308 disposed with a nail driving assembly. A trigger 312 is operably coupled with the nail driving assembly, which is coupled with the handle 310.

It is contemplated that the fastening assembly employed by the present invention may be various configurations, such as a pneumatic system, hydraulic system, alternative mechanical systems, and the like. For example, the fastening assembly may utilize the compressed air provided through the compressor connection assembly by redirecting the flow of a portion of the compressed air into a guage assembly. The guage assembly may include a readout which provides a visual indication to the operator of the angle of the nail loading assembly relative to the adjustable angle nose casting of the adjustable angle nail gun. Further, the guage assembly may include an actuator which may allow the operator of the adjustable angle nail gun to alter the flow of the compressed air into the guage assembly either increasing or decreasing the flow. Alternatively, the guage assembly may provide a bleed-off valve assembly enabling the operator to regulate the release of the compressed air in the guage assembly. Either by increasing and decreasing the air flow or bleeding-off the compressed air the operator may change the angle of the nail loading assembly relative to the adjustable angle nose casting. The guage assembly may control the angle of the nail loading assembly via a piston assembly engaging with a housing of the nail loading assembly. The piston assembly may include a piston engaging a shaft. The shaft may engaged with the housing of the nail loading assembly and as the shaft moves so does the housing. The piston moves the shaft by reacting to changing air pressures within.

An alternative mechanical system may include a ratchet assembly with a hand brake. The hand brake is engaged by the operator and through pressure applied to the hand brake the ratchet assembly raises or lowers the housing of the nail loading assembly. For example, the hand brake may include a spring loaded snap joint which provides incremental adjustments of the angle of the housing relative to the adjustable angle nose casting. The spring loaded snap joint engages a multi-position actuator which engages the ratcheting assembly. The hand brake may be disposed on the handle of the nail gun assembly to provide easy access and control over the nail gun assembly during operation of the hand brake.

In an alternative embodiment, the adjustable angle nail gun assembly 100 and 300 may be a pneumatic nail gun. Further, the adjustable angle nail gun assembly 100 and 300 may be a spring-loaded nail gun assembly. The spring-loaded nail gun assembly utilizing electricity to drive a motor which may engage a spring that drives the driver blade. In another embodiment, the adjustable angle nail gun assembly 100 and 300 may be an electromagnetic nail gun assembly utilizing a solenoid to provide the driving force to the driver blade. The solenoid may include an electromagnetic coil with a sliding piston inside it. Other embodiments of the solenoid may include a spring assembly to draw the piston back in. In a still further embodiment, the adjustable angle nail gun assembly 100 and 300 may be a combustion nail gun assembly utilizing a piston driven by the firing of gas in a combustion chamber to drive the driver blade. It is contemplated that the adjustable angle nail gun may be configured as a motor driven nail gun. Thus, the adjustable angle nail gun may be configured with electric motors and the like. Further, the motors may include clutch assemblies for providing the needed force to operate the driver blade and drive a nail. The configuration of the motor and clutch assemblies employed may vary as contemplated by one of ordinary skill in the art without departing from the scope and spirit of the present invention.

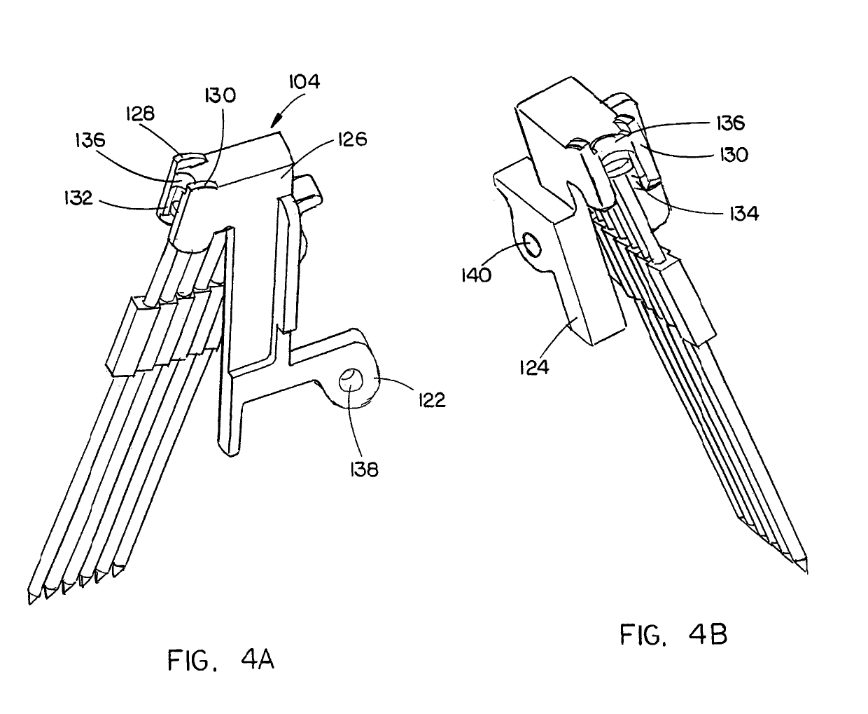

The pick-off pivot assembly 104 is shown in FIG. 4 engaged with a collated nail strip of clipped-head nails. The pick-off assembly 104 allows use of a cylindrical driver blade to drive the clipped-head nails. A cylindrical driver blade is cheaper and more robust than a crescent shaped driver blade, which is typically used to drive clipped-head nails. Through the use of the pick-off ribs the nail track is terminated slightly before the nails enter fully into the driver blade bore. This queued nail position, offset from the center of the driver blade bore, differs from conventional nail guns which allow the queued nail to continue on into the driver blade bore, stopping against the opposite wall.

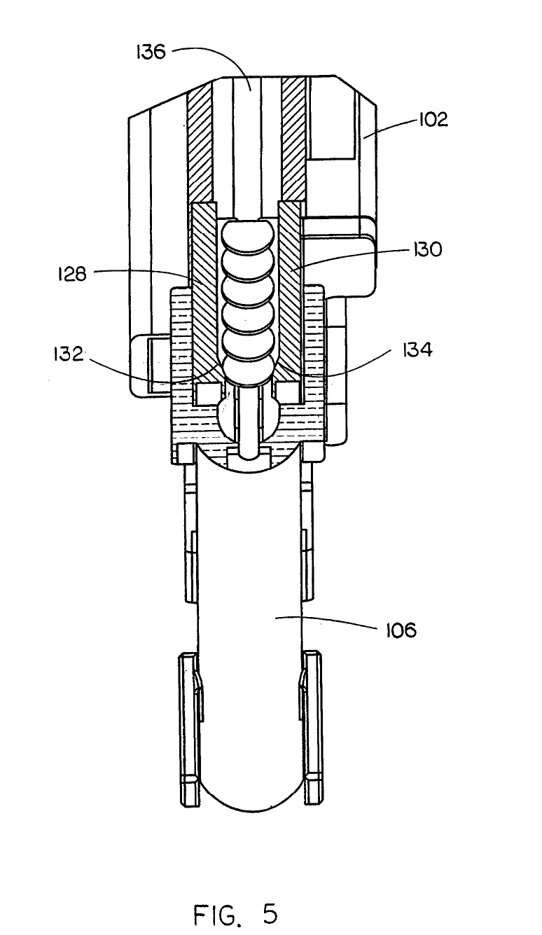

FIG. 5 shows the adjustable angle magazine 102 employing the pick-off pivot assembly 104. The adjustable angle magazine 102 is coupled with an adjustable angle nose casting assembly 106. The first and second pivot-head 128 and 130 of the pick-off pivot assembly 104, are received in the cradle of the adjustable angle nose casting assembly 106. The first and second pick-off rib 132 and 134 are shown to indicate the termination point of the nail as it is loaded into the driver blade bore of the seating member 126 and also the driver blade channel of the adjustable angle nose casting assembly 106. The pick-off pivot assembly 104 has an axis of rotation located directly under the nail head and is rigidly connected to the adjustable angle magazine 102. The pick-off ribs stop the advancing nails with the first nail located slightly under the driver blade. In this exemplary embodiment, a collated strip of clipped-head nails is being employed. However, the pick-off pivot assembly 104 is able to queue both clipped-head and round-head nails into a proper firing position even though the adjustable angle magazine 102 may be rotated relative to the adjustable angle nose casting assembly 106. Thus, the pick-off pivot assembly 104 allows for a high degree of versatility in the types of nails which may be used in the adjustable angle nail gun assembly.

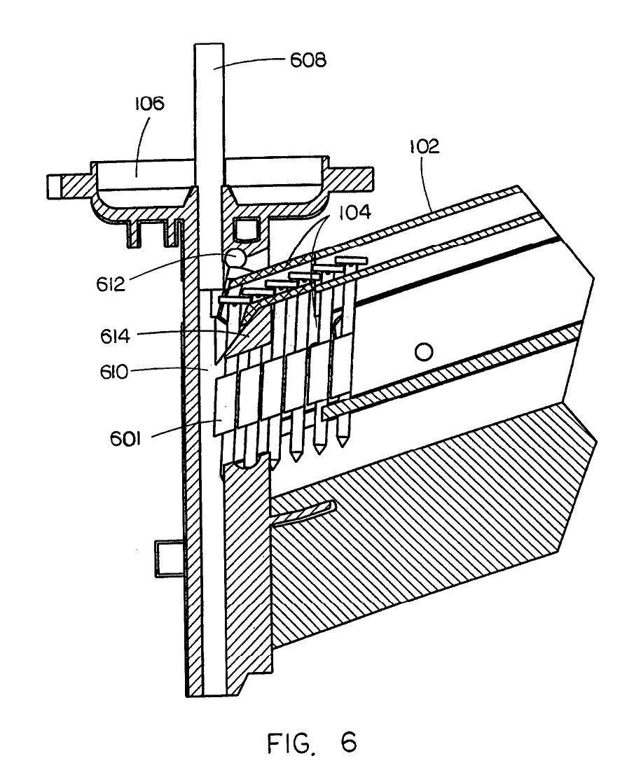

Referring now to FIG. 6, a collated strip of round-head nails 601 is loaded into the pick-off pivot assembly 104 coupled with the adjustable angle magazine 102. The adjustable angle nail loading assembly 102 is coupled with the adjustable angle nose casting assembly 106. A driver blade 608 is shown disposed in a driver blade channel 610 of the adjustable angle nose casting assembly 106. The seating member 126 is seated in a cradle and securely affixed in the seated position by a pin 612. As the driver blade 608 is driven down the first nail is “picked-off” the collated strip of nails. The nail continues to move downward causing the nail head to contact a return ramp 614, disposed within the adjustable angle nose casting assembly 106, which slides it under the driver blade. After the nail is driven, the driver blade 608 is returned up, and the collated strip of nails advances until the first nail head contacts the pick-off ribs.

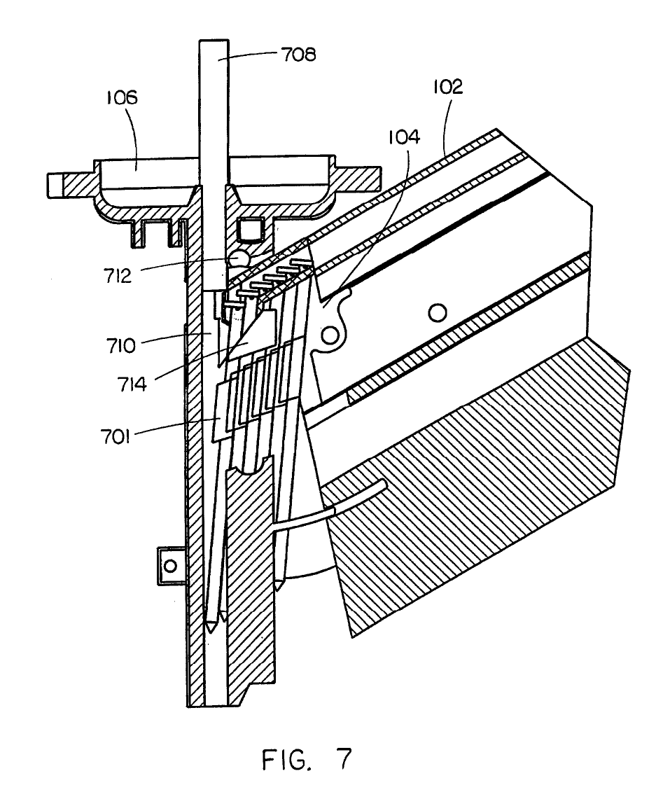

FIG. 7 shows the adjustable angle magazine 102 coupled with the pick-off pivot assembly 104, rotated to the clipped-head position for properly presenting a collated strip of clipped-head nails 701. The seating member has allowed rotation of the adjustable angle magazine 102 by rotating within the cradle of the adjustable angle nose casting assembly 106. A pin 712 securely holds the seating member in the cradle even during rotation of the adjustable angle magazine 102. The first clipped-head nail is engaged against the pick-off ribs and is slightly under a driver blade 708 within the driver blade channel 710 and the driver blade bore disposed in the seating member. A return ramp 714 is disposed within the adjustable angle nose casting assembly 106 and slides the clipped-head nail under the driver blade 708 after initial contact between the clipped-head nail and the driver blade 706 has occurred.

It is contemplated that an inter-changeable pick-off pivot assembly may be coupled with and then removed from an adjustable angle magazine. The inter-changeable pick-off pivot assembly is coupled with the adjustable angle magazine through the use of removable fasteners. The fasteners may be bolts which couple with fastening points disposed on the adjustable angle nail strip. In alternative embodiments, the fasteners may be screws, pins, and the like. Further, the coupling of the inter-changeable pick-off pivot assembly with the adjustable angle magazine may be through a compression lock assembly. For instance, the inter-changeable pick-off pivot assembly may include spring loaded pins which when aligned with the fastening points secure the location of the inter-changeable pick-off pivot assembly by extending through the fastening points. In this manner the operator may be able to remove the inter-changeable pick-off pivot assembly by applying pressure against the spring loaded pins and sliding the assembly out.

It is believed that the present invention and many of its attendant advantages may be understood by the forgoing description. It is also believed that it may be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A nail loading assembly for coupling with a nail driving assembly of a nail gun, comprising:
a housing suitable for storing a nail and providing the nail to the nail driving assembly; and
a pick-off pivot assembly coupled to the housing, the pick-off pivot assembly for pivotally coupling the housing to the nail driving assembly and providing the nail to the nail driving assembly,
wherein the pick-off pivot assembly enables the nail loading assembly to be positioned at various angles relative to the nail driving assembly and presents the nail to the nail driving assembly in the correct position.

2. The nail loading assembly of claim 1, further comprising an adjustment assembly disposed on the housing.

3. The nail loading assembly of claim 1, further comprising a cover coupled with the housing, the cover being removable from the housing.

4. The nail loading assembly of claim 1, wherein the nail loading assembly is an adjustable angle magazine.

5-12. (canceled)

13. The nail loading assembly of claim 1, wherein the nail gun is selected from the group consisting of a spring-loaded nail gun, a pneumatic nail gun, an electromagnetic nail gun, a combustion nail gun, and a motor driven nail gun.

14. (canceled)

15. An adjustable angle magazine for use with a nail gun, comprising:
a housing including a first end and a second end, the housing for storing nails and providing nails to a nail driving assembly of the nail gun;
an adjustment assembly disposed proximal to the second end of the housing, the adjustment assembly for affixing the position of the housing relative to the nail gun; and
a pick-off pivot assembly coupled to the first end of the housing, the pick-off pivot assembly for pivotally coupling the housing to the nail driving assembly and providing the nail to the nail driving assembly,
wherein the pick-off pivot assembly enables the adjustable angle magazine to be positioned at various angles relative to the nail driving assembly and present the nail to the nail driving assembly in the correct position.

16. The adjustable angle magazine of claim 15, further comprising a cover coupled with the housing, the cover being removable from the housing.

17-24. (canceled)

25. The adjustable angle magazine of claim 15, wherein the nail gun is selected from the group consisting of a spring-loaded nail gun, a pneumatic nail gun, an electromagnetic nail gun, a combustion nail gun, and a motor driven nail gun.

26. (canceled)

27. An adjustable angle nail gun, comprising:
a handle including a first end and a second end, the second end coupled with a fastening assembly;
a nail driving assembly coupled with the first end of the handle, the nail driving assembly including a driver blade, the nail driving assembly for driving a nail;
an adjustable angle nose casting assembly coupled with the nail driving assembly, the adjustable angle nose casting assembly for receiving the nail and enabling the operational engagement of the driver blade with the nail; and
an adjustable angle magazine including a first end coupled with a pick-off pivot assembly for pivotally coupling with the adjustable angle nose casting assembly and an adjustment assembly disposed proximal to a second end of the adjustable angle magazine, the adjustment assembly for coupling with the fastening assembly, the adjustable angle magazine for storing and providing a nail to the adjustable angle nose casting assembly,
wherein the pick-off pivot assembly enables the adjustable angle magazine to be positioned at various angles relative to the adjustable angle nose casting assembly and present the nail to the nail driving assembly in the correct position.

28. The adjustable angle nail gun of claim 27, wherein the adjustable angle magazine further comprises an articulating pusher assembly.

29. The adjustable angle nail gun of claim 27, wherein the adjustable angle magazine further comprises a nail checker assembly.

30. The adjustable angle nail gun of claim 27, wherein the adjustable angle magazine further comprises a nail lockout assembly.

31. The adjustable angle nail gun of claim 27, wherein the adjustable angle magazine further comprises a nail spacing verification assembly.

32. The adjustable angle nail gun of claim 27, wherein the adjustable angle magazine further comprises a nail shank pawl assembly.

33. The adjustable angle nail gun of claim 27, wherein the adjustable angle magazine further comprises a pinion nail verifier assembly.

34. The adjustable angle nail gun of claim 27, wherein the adjustable angle magazine is at least one of a top load and a side load nail loading assembly.

35. The adjustable angle nail gun of claim 27, wherein the adjustable angle magazine is a modular nail loading assembly.

36. The adjustable angle nail gun of claim 27, wherein the adjustable angle nail gun is selected from the group consisting of a spring-loaded nail gun, a pneumatic nail gun, an electromagnetic nail gun, a combustion nail gun, and a motor driven nail gun.

37. The adjustable angle nail gun of claim 27, wherein the adjustable angle nail gun further comprises a clutch assembly.

38. A nail loading assembly for coupling with a nail driving assembly of a nail gun, comprising:
means for storing a nail coupled with the nail driving assembly; and
means for providing the nail to the nail driving assembly in the correct position coupled with the means for storing the nail.

39. The nail loading assembly of claim 38, wherein the means for providing the nail in the correct position is a pick-off pivot assembly coupled with the means for storing the nail.

40. The nail loading assembly of claim 38, wherein the means for storing the nail is an adjustable angle magazine.

41. The nail loading assembly of claim 40, wherein the adjustable angle magazine further comprises an articulating pusher assembly.

42. The nail loading assembly of claim 40, wherein the adjustable angle magazine further comprises a nail checker assembly.

43. The nail loading assembly of claim 40, wherein the adjustable angle magazine further comprises a nail lockout assembly.

44. The nail loading assembly of claim 40, wherein the adjustable angle magazine further comprises a nail spacing verification assembly.

45. The nail loading assembly of claim 40, wherein the adjustable angle magazine further comprises a nail shank pawl assembly.

46. The nail loading assembly of claim 40, wherein the adjustable angle magazine further comprises a pinion nail verification assembly.

47. The nail loading assembly of claim 40, wherein the adjustable angle magazine is at least one of a top load and a side load nail loading assembly.

48. The nail loading assembly of claim 38, wherein the nail gun is selected from the group consisting of a spring-loaded nail gun, a pneumatic nail gun, an electromagnetic nail gun, a combustion nail gun, and a motor driven nail gun.

49. The nail loading assembly of claim 38, wherein the nail gun further comprises a clutch assembly.
